(19) United States
(12) Patent Application Publication
(10) Pub. No.: US 2024/0144037 A1
(43) Pub. Date: May 2, 2024

(54) MARKDOWN OPTIMIZER TO REDUCE LOSS OF PERISHABLE ITEMS

(71) Applicant: NCR Voyix Corporation, Atlanta, GA (US)

(72) Inventors: Itamar David Laserson, Givat Shmuel (IL); Norman Leonard Trujillo, Frisco, TX (US)

(21) Appl. No.: 17/977,690

(22) Filed: Oct. 31, 2022

(51) Int. Cl. G06N 5/022; G06Q 10/087; G06Q 30/0201; G06Q 30/0202

(52) U.S. Cl. CPC G06N 5/022; G06Q 10/087; G06Q 30/0202; G06Q 30/0206

(57) ABSTRACT

A network-based service is provided that utilizes a machine learning model (MLM) trained on a variety of data from disparate systems of a retailer to generate predictive guidance/parameters for a price markdown process. The predictive guidance includes a markdown prediction that indicates whether an item should or should not be marked down. For an item designated for markdown, the MLM also generates markdown parameters including a markdown level for the item and a quantity of the item to be marked down. The predictions of the MLM are optimized to reduce item shrink, reduce item spoilage, increase item sales, and increase item margins. The service can be integrated into existing retailer systems and services to provide optimal markdown instructions for perishable items that are data-driven and objective.

### BACKGROUND

One of the largest causes for shrink in retail is spoilage, i.e., perishable items that have exceeded their expiration dates. Retailers apply price markdowns as a primary technique to move at-risk inventory before spoilage occurs. Current solutions in the industry focus on the operational aspect of markdowns referred to as “reduce to clear,” rather than the decision-making aspect of inventory optimization. For example, retailers depend on store walk-throughs to manually identify inventory at risk.

Spoilage-based shrink accounts for approximately 3.1% of retail shrink overall. Departments most impacted by spoilage typically include produce, deli, bakery, prepared foods, seafood, and meat. Margins are thin for grocery stores, such that any reduction in spoilage-based shrink can substantially improve store profitability. Unfortunately, current approaches rely almost exclusively on predefined markdown policies and the experience/discretion of workers, which is not flexible, sustainable, or optimal.

### SUMMARY

In various embodiments, a system and methods for optimizing markdowns to reduce loss of perishable items are presented. A machine learning model (MLM) is trained on data relevant to markdowns associated with items subject to spoilage and shrink. The data is collected from a variety of store or retailer systems and input features are derived there from. The input features are provided as input to the MLM and the MLM produces, as output, various guidance associated with the markdown process including, without limitation, an indication as to whether a given item should or should not be marked down, and if a markdown is indicated for an item, a predicted number of markdown level(s) along with a predicted quantity of the item to markdown and a predicted price markdown at each markdown level. The MLM's predicted output is optimized to reduce item spoilage and increase item sales and margins. Item identifiers, the input features corresponding to the item identifiers, and the corresponding output from the MLM may be provided as a network-based service to a retailer. The network-based service can be integrated into existing workflows and interfaces associated with a retailer's markdown processes so as to provide enhanced features to the existing workflows and interfaces, which in turn, increase each item's sales and margins, while at the same time decreasing each item's spoilage and shrink rates.

### BRIEF DESCRIPTION OF THE DRAWINGS

FIG. 1 is a diagram of a system for optimizing markdowns to reduce loss of perishable items, according to an example embodiment.

FIG. 2A is a flow diagram of a method for optimizing markdowns to reduce loss of perishable items, according to an example embodiment.

FIG. 2B is a flow diagram illustrating additional embodiments of the method of FIG. 2A.

FIG. 3A is a flow diagram of another method for optimizing markdowns to reduce loss of perishable items, according to an example embodiment.

FIG. 3B is a flow diagram illustrating additional embodiments of the method of FIG. 3A.

### DETAILED DESCRIPTION

Current approaches directed to reducing spoilage-based shrink are based on predefined policies and the experience/discretion of workers. Typically, a price markdown is a process by which a store associate manually reduces prices of soon-to-be expired products by printing and attaching a dedicated barcode to each item being marked down. The predefined policy may call for multiple levels of price markdown associated with price markdown amounts. For example, a level-1 markdown could be a 10% discount while a level-4 markdown could be a 40% markdown. Store associates markdown items on a daily basis, and if needed, they may increase the level of markdown for items that were not sold the day before.

Markdowns are an effective way to reduce shrink of perishable items, but there are various disadvantages. For example, existing solutions do not provide an effective way to track markdowns and at-risk inventory. The current approaches focus on facilitating operational implementation of the predefined policies but do not capture sufficient data on the markdown process and the at-risk inventory to provide an optimized, decision-based markdown process. For example, data that is not captured by existing solutions includes, among other things, product expiration date, markdown cycle (e.g., markdown level), total number of units marked down, and total number of marked down items sold. Even assuming availability of the markdown data identified above, the data is dispersed across multiple logs, data stores, and systems of the retailer such that conventional solutions fail to collect, assemble, and/or process the data in an optimal manner.

Additionally, in conventional approaches, the discretion and experience of store associates play a significant role in how markdowns are made. This discretion may include manual, intuition-based decisions relating to 1) the amount of time before an item's expiration date to initiate a markdown, 2) how many items to mark down on any given day, 3) what level of markdown to apply to a given item; and 4) what items recently received from the warehouse have limited shelf lives. While other store employees may have oversight of the store associate's markdowns, these employees also largely base their decisions on intuition and experience. This manual, experience/intuition-based approach, however, fails to consider such things as: 1) what is the impact on sales for each markdown level, 2) how are markdowns impacting, sales, margin, and shrink within a given item category, 3) what is the impact of markdowns on other adjacent items (e.g., similar items or complimentary items), and 4) how are markdown items impacting item returns and/or customer complaints.

These additional considerations during the markdown process are important, not only to reduce shrink but also to manage store-level sales and margins as well as shopper behaviors. For instance, some shoppers may avoid buying items at their regular price and may look only for markdowns before making a purchase. That is, customers may look for markdowns as an incentive to purchase items that they otherwise may not have. In other scenarios, a comprehensive analysis may suggest that retailer will actually lose less if they intentionally avoid marking down certain items, and instead absorbing the cost of spoilage. Thus, because existing solutions rely on human intuition alone and fail to optimize the markdown process based on data-driven, predictive analytics that assesses variables that influence the broader impact of the markdown process, they fail to identify the underlying factors/circumstances that could result in the markdown process negatively impacting the overall sales of a store.

As will be demonstrated herein and below, the above-noted technical problems associated with the existing manual, intuition-driven approaches for determining when and how to perform a markdown are solved by embodiments of the technology disclosed herein according to which historical markdown-related data is captured from multiple disparate data sources and provided as input to a machine learning model (MLM) that predicts various markdown parameters including, without limitation, the timeframe of a markdown (e.g., when to initiate a markdown of an item, how many markdown level(s) to go through, the duration of each markdown level, etc.); the price discount to apply for each markdown level; the impacts of the markdown on item inventory, sales, margins, and customer behavior; and so forth. The MLM is optimized and continuously retrained to improve its F1 predicted values based on actual outcomes associated with marked down items. The predicted values produced by the MLM may be integrated into existing markdown workflows/interfaces and monitored for accuracy from retail systems.

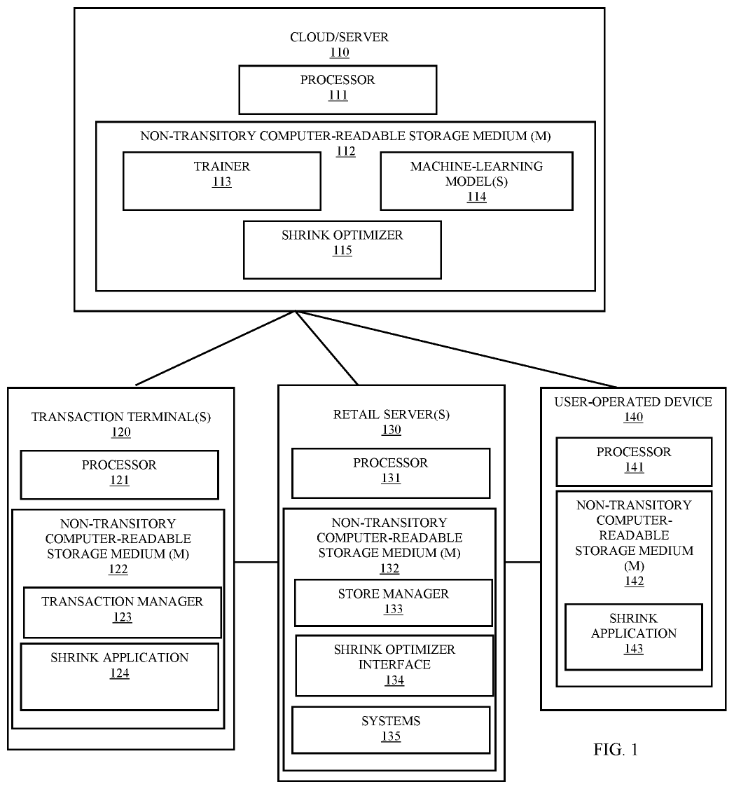

FIG. 1 is a diagram of a system 100 for optimizing markdowns to reduce loss of perishable items, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of optimizing markdowns to reduce loss of perishable items presented herein and below.

System 100 is data-driven and provides real-time and dynamic optimized markdown predictions and instructions for marking down items of a store. The predictions and instructions are integrated into existing workflows, existing services, existing interfaces, and existing systems as data-driven enhancements to markdown processes.

System 100 includes a cloud 110 or a server 110 (hereinafter simply “cloud 110”), transaction terminals 120, retail servers 130, and user-operated devices 140. Cloud 110 includes a processor 111 and a non-transitory computer-readable storage medium 112, which includes executable instructions for a trainer 113, one or more MLMs 114, and a shrink optimizer 115. Processor 111 obtains or is provided the executable instructions from medium 112 causing processor 111 to perform operations discussed herein and below with respect to 113-115.

Each transaction terminal 120 includes a processor 121 and a non-transitory computer-readable storage medium 122, which includes executable instructions for a transaction manager 123 and a shrink application 124. Processor 121 obtains or is provided the executable instructions from medium 122 causing processor 121 to perform operations discussed herein and below with respect to 123-124.

Each retailer server 130 includes a processor 131 and a non-transitory computer-readable storage medium 132, which includes executable instructions for a store manager 133, a shrink optimizer interface 134, and a variety of systems 135. Processor 131 obtains or is provided the executable instructions from medium 132 causing processor 131 to perform operations discussed herein and below with respect to 133-135.

Each user-operated device 140 includes a processor 141 and a non-transitory computer-readable storage medium 142, which includes executable instructions for a shrink application (app) 143. Processor 141 obtains or is provided the executable instructions from medium 142 causing processor 141 to perform operations discussed herein and below with respect to 143.

Trainer 113 trains MLM 114 on input features to produce fine-grained predictions. The input features may be based on actual observed information associated with previous markdowns on previous items within a given store of the retailer. The input features can be obtained by trainer from systems 135 and/or store manager 133 of a given retailer associated with the given store.

For example, trainer 113 can obtain a listing of perishable items for a given store that is subject to spoilage (and thus shrink) when the items fail to sell before their expiration date. This listing can be obtained from an item catalogue system 135 of retail server 130 for a given retail store. Each item may be identified by an item type within the list; for example, chicken breasts, pre-peeled shrimp, T-bone steak, etc. Trainer 113 assembles training data sets for each item type using historical data captured by systems 135.

Each training data set for each item type includes historical data gathered by trainer 113 over a given interval of time (e.g., a week, a day, a few days, two weeks, etc.). For each interval of time, trainer 113 obtains, from the historical data, a total number of items of the given item type (hereinafter referred to a “units of the item”) available for sale at the store. The available units for the current interval of time can be obtained from historical data associated with the retailer's inventory system 135 and transaction system 135. Trainer 113 retains the available units in the corresponding training data set for the current interval of time as a first labeled input feature to MLM 114.

Next, for the current interval of time, trainer 113 obtains the expiration date for each unit, which can be obtained from an inventory system 135 when the item unit was scanned into inventory at the store. The expiration date data for the current interval of time is retained within the corresponding training data set as a second labeled input feature to MLM 114.

Trainer 113 also identifies, for each day within the current interval of time, the number of days until the expiration date for a given unit. The number of days until expiration for each unit of item within the current interval of time is retained as a third labeled input feature to MLM 114.

For the current interval of time, trainer 113 identifies how many units of a given item are already marked down from their original listed price using historical data associated with the store's inventory and/or transaction systems 135 where a price change would appear for the item. The total number of units already marked down in the current interval of time is retained as a fourth labeled input feature to MLM 114. The total number of markdown cycles active for the units is also determined based on the markdown levels identified for the units of the given item type present in the current interval of time, and this may be retained, along with the current interval of time, as a fifth labeled input feature to MLM 114. The original price of each unit may also be identified from the historical data and retained, along with the current interval of time, as a sixth labeled input feature to MLM 114.

Next, for each current interval of time, sales data associated with each unit, and broken down by that unit's markdown levels (e.g., markdown cycles) for a given day and a given item, may be obtained from the transaction system 135 and retained, along with the current interval of time, within the corresponding training data set as a seventh labeled input feature to MLM 114.

Trainer 113 may also calculate spoilage per day for a given item type as an eighth labeled input feature to MLM 114. This can be calculated based on units that expired before a sale of the units occurred, from the historical data of the transaction system 135. This spoilage per day per item type data may be retained as a ninth labeled input feature to MLM 114. Trainer 113 also identifies a shrink reduction for the given item type based on items that sold in a markdown cycle before expiration and may retain this data as a tenth labeled input feature to MLM 114.

Trainer 113 may then obtain data relating to similar or complementary items to a given item of a given item type from existing analytics associated with analytic services of the retailer. These analytic services may leverage multiple data sources including the item catalogue system 135, transaction system 135, and/or inventory system 135. The trainer 113 may retain item identifiers for the similar or complementary items as eleventh labeled input features to MLM 114.

Next, trainer 113 obtains historical forecasted demand for the item. Forecasting systems 135 or services for the item may generate the historical forecasted demand data. This is retained as a twelfth labeled input feature.

The training data sets for each item may include the aforementioned twelve labeled input features across multiple intervals of time. In example embodiments, the expected output from the MLM 114 when provided an item's training data set may include a set of markdown parameters including a type of markdown (markdown level and/or markdown amount) and a quantity of units of the item to markdown. The markdown parameters may be optimized to reduce item shrink, increase item margins, and/or increase item sales. In some embodiments, when a threshold F1 score is attained by MLM 114—which may be reflected in decreased item shrink, increased item margins, and/or increase item sales—trainer 113 releases MLM 114 for production use by shrink optimizer 115. In an example embodiment, output from MLM 114 includes a predicted markdown level or markdown discount for a given item and a total quantity of the item to markdown on a given day within a store.

During operation of system 100, a store associate at the beginning of a business day for the store operates either terminal 120 or device 140 for purposes of identifying the items that are within a predefined time of expiring. This can be done in a variety of manners such as by utilizing an existing workflow associated with an existing markdown process that is enhanced to include shrink app 124 and/or shrink app 143. When a barcode for an item that is within the predefined time of expiring is scanned using a portable scanner or other user-operated device 140, the enhanced workflow sends the item code or item identifier to shrink optimizer 115.

Shrink optimizer 115 obtains input features for the item and passes the input features as input to MLM 114. The input features for the item may relate to some historical period of time (e.g., the prior day). MLM 114 returns an indication whether the given item associated with the item identifier should or should not be marked down, and if a markdown is provided, the MLM 114 also includes a markdown level for the item and a total quantity of units of the item to which to apply the markdown level. Shrink optimizer 115 may obtain the sales and demand forecast for the item from a same analytics system 135 or service used by the store. The sales and demand forecast calculated for the item may be provided as one of the input features to MLM 114.

The item codes or identifiers can be entered through a user-interface associated with app 124. For example, a user may scan the items that are within a predefined time of expiring and/or a store associate can walk the department of the store using a laptop 140, phone 140, or handheld scanner 140 to scan the barcodes on the items. Shrink applications 124 and 143 provide each item code to shrink optimizer 115. Shrink optimizer 115 maintains current input features for each of the store's perishable items, including sales and demand forecasts, and provides each item's input features as input to MLM 114. MLM 114 returns the indication as to whether the given item should or should not be marked down, and if the item is designated for markdown, the markdown level and the quantity of units for the item to which to apply the markdown. Shrink optimizer 115 may return this information back to user interfaces associated with shrink application 124 and shrink application 143.

The above-discussed approach reduces item shrink, increases item margin, and increases item sales for each item through the predictive capabilities of MLM 114. MLM 114 may be trained on data associated with the above-discussed input features, which as noted earlier, may be collected from a variety of systems 135 and services of a retailer. In example embodiments, MLM 114 not only weighs the negative impact of spoilage or waste but also a evaluates the tradeoff between the negative impact of spoilage and the negative impacts of markdowns on broader, long-term shopper behavior. Because MLM 114 is continuously re-trained through trainer 113 with actual results to create a feedback loop that improves the F1 values and optimizes the markdown process to minimize item spoilage and increase item margins and item sales, scenarios that result in negative shopping behavior influenced by the markdown process would manifest as decreased sales, decreased margins, increased spoilage, and/or decreased item sales forecasts, and thus, would be identifiable and addressable by the MLM 114. System 100 replaces static store markdown policies and discretionary managerial oversight with an objective and data-driven approach to item markdowns on a micro level and to sales and margins of a given store on a macro level. System 100 can be fully integrated and provided to retailers as a cloud-based service that enhances the retailers' existing systems 135, workflows, and services.

In an embodiment, an existing markdown service/user interface of a given retailer is enhanced with a workflow that calls shrink optimizer 115 for each scanned or entered item code. The user interface is further enhanced to provide the markdown indication, the markdown level, and the quantity of item units to be subjected to any markdown.

In an embodiment, shrink optimizer interface 134 includes a user interface associated with shrink optimizer 115 for purposes of requesting and generating reports on a daily basis for each store of a retailer. The reports may list an item identifier for each item of a given store to be marked down, its markdown level, and the quantity of units of the item to mark down. Shrink optimizer 115 may maintain up-to-date inventory levels for each item of the store using the retailer's store manager 133 and inventory system 135 and the store's transaction system 135, which obtains real-time sales data from transaction manager 123 of terminals 120. Shrink optimizer interface 134 and/or shrink optimizer 115 can further push the daily reports directly to terminals 120 and devices 140 for displaying to store associates via apps 124 and 143. In this way, the conventional approach associated with scanning item identifiers for items that are within a predefined time of expiring can be eliminated or supplemented with the daily store reports.

In an embodiment, shrink optimizer 115 maintains metrics for each item based on its current spoilage, sales, and margin, such that when spoilage is increasing and/or sales and margins decreasing, optimizer 115 may initiate a feedback re-training session through trainer 113. In example embodiments, trainer 113 maintains past input features associated with item data for a given store that were identified subsequent to a last training session with MLM 114 and initiates a new training session with MLM 114. A feedback loop is created to maintain the proper acceptable F1 values for MLM 114 to ensure optimization with respect to reducing spoilage and increasing item margins and sales.

In an embodiment, shrink optimizer 115 is provided as a software-as-a-service (SaaS) to systems 135 and existing enhanced services of a retailer. In this way, system 100 can be fully integrated into an existing retailer's markdown process via a call (e.g., an application programming interface (API) call) to shrink optimizer 115 from these existing systems 135 and services to established enhanced systems 135 and enhanced services for the retailer.

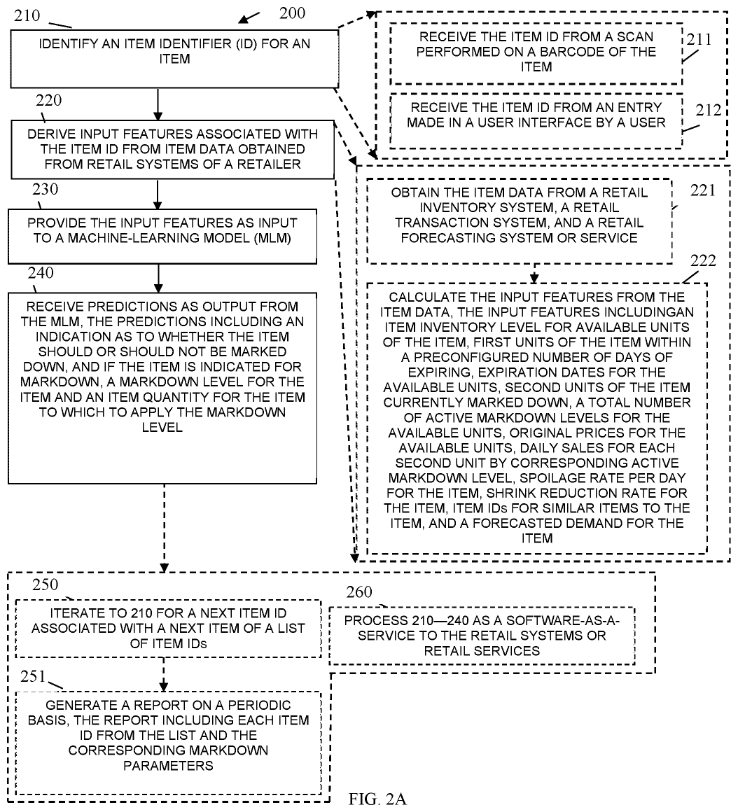

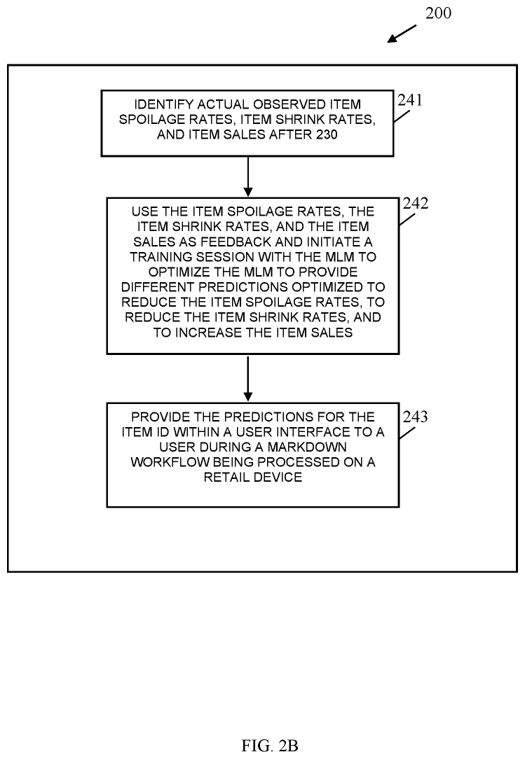

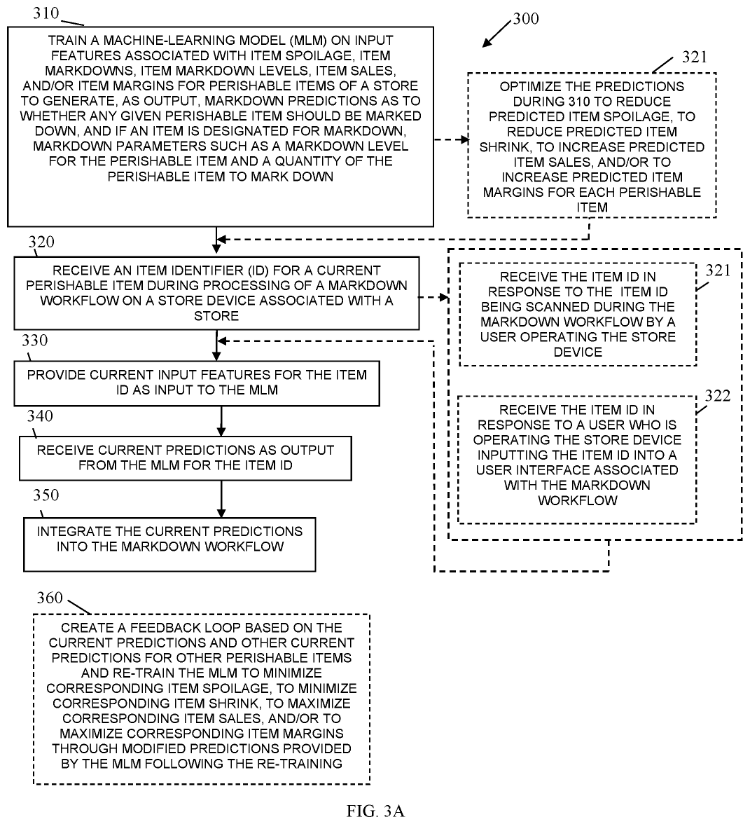

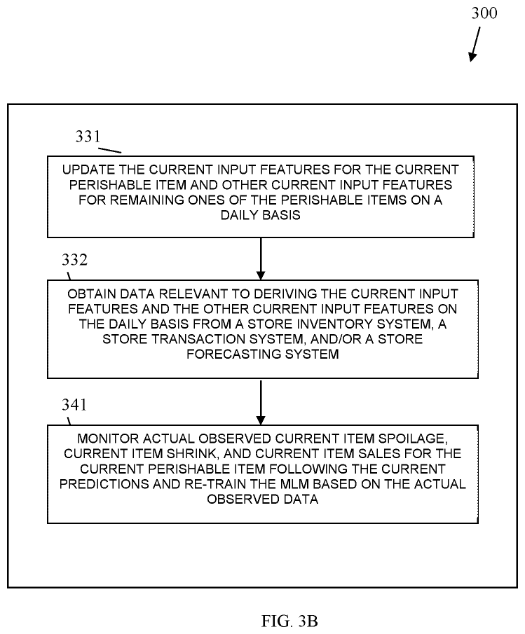

The above-referenced embodiments and other embodiments will now be discussed with reference to FIGS. 2A, 2B, and 3. FIGS. 2A and 2B illustrate a flow diagram of a method 200 for optimizing markdowns to reduce loss of perishable items, according to an example embodiment. The software module(s) that implements the method 200 is referred to as an “item markdown optimizer.” The item markdown optimizer is implemented as executable instructions programmed and residing within memory and/or a non-transitory computer-readable (processor-readable) storage medium and executed by one or more processors of one or more devices. The processor(s) of the device(s) that executes the item markdown optimizer are specifically configured and programmed to process item markdown optimizer. The item markdown optimizer has access to one or more network connections during its processing. The connections can be wired, wireless, or a combination thereof.

In an embodiment, the device that executes item markdown optimizer is cloud 110. In an embodiment, the device that executes item markdown optimizer is server 110. In an embodiment, the device that executes item markdown optimizer is a retail server 130. In an embodiment, the item markdown optimizer is all of, or some combination of 113, 114, and/or 115. In an embodiment, the item markdown optimizer is provided to a retail server 130, retail terminal 120, retail system 135, retail service, and/or a user-operated device 140 as a SaaS.

At 210 (shown in FIG. 2A), the item markdown optimizer identifies an item identifier for an item. The item identifier can be received from a variety of retail services, retail markdown workflows, retail systems 135, and/or through other mechanisms discussed herein.

In an embodiment, at 211 (shown in FIG. 2A), the item markdown optimizer receives the item identifier from a scan performed on a barcode of the item. This can be received through a user interface of app 124 and/or 143 when an item is scanned by a store associate at the start of a business day. Moreover, the device 140 from which the scanned barcode is received can be a portable standalone scanner, a phone, a tablet, or a wearable processing device.

In another embodiment, at 212 (shown in FIG. 2A), the item markdown optimizer receives the item identifier from an entry made in a user interface by a user. For example, a user interface of app 124 and/or 143 may include an item identifier entry field where a user or an associate can manually enter the item identifier into the entry field. The item identifier thus entered may then be received by item markdown optimizer.

At 220 (shown in FIG. 2A), the item markdown optimizer derives input features associated with the item identifier from item data obtained from retail systems 135 of a retailer. The input features can be calculated from the item data in any of the manners that were discussed above for system 100.

In an embodiment, at 221 (shown in FIG. 2A), the item markdown optimizer obtains the item data from a retail inventory system 135, a retail transaction system 135, and/or a retail forecasting system 135 or retail forecasting service. In an embodiment of 221, and at 222 (shown in FIG. 2A), the item markdown optimizer calculates the input features from the item data. The input features may include, without limitation, an item inventory level of available units of the item; first units of the item that are within a preconfigured number of days of expiring; expiration dates for the available units; second units of the item inventory currently marked down; a total number of active markdown levels for the available units; original (pre-markdown) prices for the available units; daily sales (or some other periodic time period) for each second unit by corresponding active markdown level; spoilage rate per day (or some other periodic time period) for the item; shrink reduction rate for the item; item identifiers for similar items to the item; and a forecasted demand or sales for the item.

At 230 (shown in FIG. 2A), the item markdown optimizer provides the input features as input to a MLM 114. The MLM 114 may be trained on the input features as was discussed above with system 100.

At 240 (shown in FIG. 2A), the item markdown optimizer receives predictions (markdown parameters) as output from the MLM 114. The predictions include an indication as to whether the item should or should not be marked down, and if the item is designated for markdown, a markdown level for the item and an item quantity for the item to which to apply the markdown level.

In an embodiment, and at 241 (shown in FIG. 2B), the item markdown optimizer identifies actual observed item spoilage rates, item shrink rates, and item sales after 240. This is to monitor whether the predictions are optimally performing for reducing spoilage and shrink while also increasing sales and margins.

At 242 (shown in FIG. 2B), the item markdown optimizer uses the item spoilage rates, the item shrink rates, and the item sales as feedback. The item markdown optimizer initiates a training session with the MLM 114 to optimize the MLM 114 to provide different predictions optimized to reduce the item spoilage rates, to reduce the item shrink rates, and/or to increase item sales and correspondingly item margins.

At 243 (shown in FIG. 2B), the item markdown optimizer provides the predictions for the item identifier within a user interface during a markdown workflow being processed on a retail device 120 or 140. That is, an existing workflow and its user interface may be enhanced to provide the item identifier to the item markdown optimizer and receive the predictions for the corresponding item from the item markdown optimizer.

In an embodiment, at 250 (shown in FIG. 2A), the item markdown optimizer iterates to 210 for a next item identifier associated with a next item of a list. In an embodiment of 250, and at 251 (shown in FIG. 2A), the item markdown optimizer generates a report for the list on a periodic (e.g., daily) basis. The report includes each of the item identifiers associated with perishable items of a store and their corresponding predictions generated by the MLM 114. This can be provided on a daily basis through shrink optimizer interface 134.

In an embodiment, at 260, the item markdown optimizer (210-240) executes as a SaaS to the retail systems 135 and/or to retail services. That is the systems 135 and services can be enhanced to provide the item identifier to the item markdown optimizer and receive the predictions for the item identifier generated by the MLM 114 through item markdown optimizer.

FIGS. 3A and 3B illustrate a flow diagram of another method 300 for optimizing markdowns to reduce loss of perishable items, according to an example embodiment. The software module(s) that implements the method 300 is referred to as an “item markdown manager.” The item markdown manager is implemented as executable instructions programmed and residing within memory and/or a non-transitory computer-readable (processor-readable) storage medium and executed by one or more processors of one or more devices. The processor(s) of the device(s) that executes the item markdown manager are specifically configured and programmed to process the item markdown manager. The item markdown manager has access to one or more network connections during its processing. The network connections can be wired, wireless, or a combination of wired and wireless.

In an embodiment, the device that executes the item markdown manager is cloud 110. In an embodiment, the device that executes the item markdown manager is server 110. In an embodiment, the device that executes the item markdown manager is retail server 130. In an embodiment, the item markdown manager is provided to a retail server 130, a retail terminal 120, a retail system 135, a retail service, and/or a user-operated device 140 as a SaaS.

In an embodiment, the item markdown manager is all of, or some combination of 113, 114, 115, and/or method 200. The item markdown manager presents another and, in some ways, enhanced processing perspective from that which was discussed above with the method 200 and system 100.

At 310 (shown in FIG. 3A), the item markdown manager trains an MLM 114 on input features associated with item spoilage, item markdowns, item markdown levels, item sales, and/or item margins for perishable items of a store. The MLM 114 is trained to provide markdown predictions as to whether or not any given perishable item should be marked down, and if an item is designated by the MLM 114 for markdown, markdown parameters such as a markdown level for the perishable item to be marked down and a quantity of the perishable item to be marked down.

In an embodiment, at 311 (shown in FIG. 3A), the item markdown manager optimizes the predictions during 310 to reduce predicted item spoilage, to reduce predicted item shrink, to increase predicted item sales, and/or to increase predicted item margins for each perishable item. That is, the predictions are optimized to account for micro-level conditions and macro-level conditions of the store.

At 320, (shown in FIG. 3A), the item markdown manager receives an item identifier for a current perishable item during processing of a markdown workflow on a store device 120 or 140 associated with a store. The markdown workflow may be an existing workflow that is enhanced to call the item markdown manager and to receive predictions from the item markdown manager for any given item identifier.

In an embodiment, at 321 (shown in FIG. 3A), the item markdown manager receives the item identifier in response to the item identifier being scanned during the markdown workflow by a user operating the store device 120 or 140. The device 140 can be a handheld scanner, a phone, a tablet, a laptop, or a wearable processing device.

In an embodiment, at 322 (shown in FIG. 3A), the item markdown manager receives the item identifier in response to a user who is operating the store device 120 or 140 inputting the item identifier into a user interface associated with the markdown workflow. For example, the user inputs the item identifier through a user interface associated with app 124 or app 143.

At 330 (shown in FIG. 3A), the item markdown manager provides the current input features for the item identifier as input to the MLM 114. The MLM 114 was already trained at 310 and released for use at 330 in response to acceptable F1 values being identified during training.

In an embodiment, at 331 (shown in FIG. 3B), the item markdown manager updates the current input features for the current perishable item and other current input features for remaining ones of the perishable items on a daily basis. That is, at the end of each business day, the item markdown manager updates the current input features for each of the perishable items such that they are available for the next business day at the store.

In an embodiment of 331, and at 332 (shown in FIG. 3B), the item markdown manager obtains data relevant to deriving the current input features and the other current input features on a daily basis from a store inventory system 135, a store transaction system 135, and a store forecasting system 135 or store forecasting service. The input features are derived from the data for each of the perishable items.

At 340 (shown in FIG. 3A), the item markdown manager receives current predictions as output from the MLM 114 for the item identifier. In an embodiment of 332 and 340, at 341 (shown in FIG. 3B), the item markdown manager monitors actual observed current item spoilage, current item shrink, and current item sales/margins for the current perishable item following the current predictions and re-trains the MLM 114 based thereon.

At 350 (shown in FIG. 3A), the item markdown manager integrates the current predictions into the markdown workflow. For example, user interface screens are updated to instruct an associate on the item that needs markdown, the markdown level, and a quantity of the item to which to apply the markdown level.

In an embodiment, at 360 (shown in FIG. 3A), the item markdown manager creates a feedback loop based on the current predictions and other current predictions for other perishable items. The item markdown manager retrains the MLM 114 to minimize corresponding item spoilage, to minimize corresponding item shrink, to maximize corresponding item sales, and to maximize corresponding item margins through modified predictions provided by the MLM 114 following re-training.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
identifying an item identifier for an item;
deriving input features associated with the item identifier from item data obtained from retail systems of a retailer;
providing the input features as input to a machine learning model (MLM);
receiving a markdown prediction as output from the MLM, wherein the markdown prediction indicates whether the item should or should not be marked down; and
providing the markdown prediction for the item identifier to a retail device.

2. The method of claim 1, wherein the markdown prediction indicates that the item should be marked down, and wherein the method further comprises:
receiving, as further output from the MLM, markdown parameters including a markdown level for the item and an item quantity of the item to which to apply the markdown level; and
providing the markdown parameters to the retail device.

3. The method of claim 1, further comprising iterating to the identifying for a next item identifier associated with a next item of a list of item identifiers.

4. The method of claim 3, further comprising generating a report for the list on a daily basis, wherein the report comprises each of the item identifiers of the list and the corresponding predictions.

5. The method of claim 1, further comprising processing the method as a software-as-a-service to the retail systems or retail services.

6. The method of claim 1, wherein identifying further includes receiving the item identifier from a scan performed on a barcode of the item.

7. The method of claim 1, wherein identifying further includes receiving the item identifier from input received from a user at a user interface.

8. The method of claim 1, wherein deriving further includes obtaining the item data from at least one of a retail inventory system, a retail transaction system, or a retail forecasting system/service.

9. The method of claim 8, wherein deriving further includes calculating the input features from the item data, the input features including an item inventory level for available units of the item, first units of the item within a preconfigured number of days of expiring, expiration dates for the available units of the item, second units of the item currently being marked down, a total number of active markdown levels for the available units, original prices for the available units, sales by day for each second unit by the corresponding active markdown level, spoilage rate per day for the item, shrink reduction rate for the item, item identifiers for similar items to the item, and a forecasted demand for the item.

10. The method of claim 1, wherein receiving further includes identifying actual observed item spoilage rates, item shrink rates, and item sales after providing the predictions.

11. The method of claim 9, further comprising using the item spoilage rates, the item shrink rates, and the item sales as feedback and initiating a training session with the MLM to optimize the MLM to provide different markdown predictions optimized to reduce the item spoilage rates, reduce the item shrink rates, and increase the item sales.

12. The method of claim 1, wherein providing further includes providing the markdown prediction for the item identifier to a user within a user interface during a markdown workflow being processed on a retail device.

13. A method, comprising:
training a machine learning model (MLM) on input features associated with item spoilage, item shrink, item markdowns, item markdown levels, item sales, and item margins for perishable items of a store to generate markdown predictions and markdown parameters as output, each markdown prediction indicating whether a given perishable item should or should not be marked down, and the markdown parameters indicating, for each perishable item indicated for markdown, a markdown level and a quantity of the perishable item that is to be marked down;
receiving an item identifier for a current perishable item during processing of a markdown workflow on a store device associated with the store;
providing current input features for the item identifier as input to the MLM receiving current predictions as output from the MLM for the item identifier; and
integrating the current predictions into the markdown workflow.

14. The method of claim 13, wherein training further includes optimizing the predictions during the training to reduce predicted item spoilage, to reduce predicted item shrink, to increase predicted item sales, and to increase predicted item margins for each perishable item.

15. The method of claim 13, wherein receiving further includes receiving the current item identifier in response to the current item identifier being scanned during the markdown workflow by a user operating the store device.

16. The method of claim 13, wherein receiving further includes receiving the current item identifier in response to a user operating the store device inputting the current item identifier into a user interface associated with the markdown workflow.

17. The method of claim 13, wherein providing further includes updating the current input features for the current perishable item and other current input features for remaining ones of the perishable items on a daily basis.

18. The method of claim 11 further comprising, creating a feedback loop based on the current predictions and other current predictions for other perishable items and retraining the MLM to minimize corresponding item spoilage, to minimize corresponding item shrink, to maximize corresponding item sales, and to maximize corresponding item margins through modified predictions provided by the MLM following the retraining.

19. A system, comprising:
a cloud server comprising at least one processor and a non-transitory computer-readable storage medium,
the non-transitory computer-readable storage medium comprising executable instructions,
wherein the executable instructions, when executed by the at least one processor cause the at least one processor to perform operations comprising:
training, per perishable item of a store, a machine learning model (MLM) on data relevant to item spoilage, item shrink, item margin, and item profit to produce as output markdown predictions as to whether the perishable item should or should not be marked down, and markdown parameters if the perishable item is indicated for markdown, the markdown parameters including a markdown level for the perishable item and a quantity of the perishable item to markdown;
updating the data daily from retailer systems of a retailer to maintain current data for each of the perishable items;
obtaining current predictions provided by the MLM for the current data in response to receiving perishable item identifiers for current perishable items from a workflow associated with item markdowns of a store; and
integrating the current predictions into a user interface associated with the workflow.

20. The system of claim 19, wherein the retail systems comprise a store inventory system, a store transaction system, and a store forecasting system.
